(19) United States
(12) Patent Application Publication
(10) Pub. No.: US 2019/0087856 A1
(43) Pub. Date: Mar. 21, 2019

(54) METHOD AND APPARATUS FOR PUBLISHING MULTIMEDIA DATA, SERVER AND STORAGE MEDIUM

(71) Applicant: TENCENT TECHNOLOGY (SHENZHEN) COMPANY LIMITED, Shenzhen (CN)

(72) Inventors: Rijia LIU, Shenzhen (CN); Zhibin Liu, Shenzhen (CN); Bo Zheng, Shenzhen (CN)

(73) Assignee: TENCENT TECHNOLOGY (SHENZHEN) COMPANY LIMITED, Shenzhen (CN)

(21) Appl. No.: 16/197,138

(22) Filed: Nov. 20, 2018

Related U.S. Application Data
(63) Continuation of application No. PCT/CN2017/095251, filed on Jul. 31, 2017.

(30) Foreign Application Priority Data
Sep. 9, 2016 (CN) 201610814122.3

(51) Int. Cl. G06Q 30/02; H04L 29/08

(52) U.S. Cl. CPC G06Q 30/0246; G06Q 30/0244; H04L 67/22; G06Q 30/0269; G06Q 30/0255

(57) ABSTRACT

A method for publishing multimedia data is disclosed. A user identifier of a user using a terminal and a target media position of the terminal are obtained. A plurality of multimedia data to be published is acquired. An outcome, associated with each of the plurality of multimedia data when the respective multimedia data is published at the target media position, is determined based on a set of characteristics. The set of characteristics includes at least one of a first credit characteristic, a second credit characteristic and a third credit characteristic, a user characteristic of the user identifier, a content characteristic of the respective multimedia data, and a position characteristic of the target media position. Based on the outcomes associated with the plurality of multimedia data, the target multimedia data is selected from the plurality of multimedia data, and sent to the terminal to be published at the target media position.

### RELATED APPLICATION

This application is a continuation of International Application No. PCT/CN2017/095251, filed on Jul. 31, 2017, which claims priority to Chinese Patent Application No. 201610814122.3 filed with the Chinese Patent Office on Sep. 9, 2016. The entire disclosures of the prior applications are hereby incorporated by reference in their entirety.

### FIELD OF THE TECHNOLOGY

Embodiments of the present disclosure relate to the field of Internet technologies.

### BACKGROUND OF THE DISCLOSURE

With the development of Internet technologies, a spread range of network information gradually increases, and more advertisements start to spread in the form of network advertisement. A large number of media applications exist in the network, and the media applications provide a lot of media positions for many advertisements. Therefore, how to determine an advertisement to be published at each media position becomes a problem that needs to be resolved.

### SUMMARY

To resolve a related technical problem, embodiments of the present disclosure provide a method and an apparatus for publishing multimedia data, a server, and a storage medium. The technical solutions are as follows:

According to an aspect of the embodiments of this application, a method for publishing multimedia data is provided. A user identifier of a user using a terminal and a target media position that is used to publish target multimedia data are obtained. A plurality of multimedia data to be published is acquired. An outcome, associated with each of the plurality of multimedia data when the respective multimedia data is published at the target media position, is determined based on a set of characteristics. The set of characteristics includes at least one of a first credit characteristic, a second credit characteristic and a third credit characteristic, a user characteristic of the user identifier, a content characteristic of the respective multimedia data, and a position characteristic of the target media position. The first credit characteristic corresponds to a credit characteristic of the user. The second credit characteristic corresponds to a credit characteristic of an owner group associated with the respective multimedia data. The third credit characteristic corresponds to a credit characteristic of users associated with the target media position. The users include visiting users and clicking users. The target multimedia data is selected from the plurality of multimedia data based on the outcomes associated with the plurality of multimedia data. The target multimedia data is sent to the terminal to be published at the target media position.

According to an aspect of the embodiments of this application, an information processing apparatus for publishing multimedia data is provided. The information processing apparatus includes processing circuitry that obtains a user identifier of a user using a terminal and a target media position that is used to publish target multimedia data by the terminal. The information processing apparatus acquires a plurality of multimedia data to be published. The processing circuitry determines, based on a set of characteristics, an outcome associated with each of the plurality of multimedia data when the respective multimedia data is published at the target media position. The set of characteristics includes at least one of a first credit characteristic, a second credit characteristic and a third credit characteristic, a user characteristic of the user identifier, a content characteristic of the respective multimedia data, and a position characteristic of the target media position. The first credit characteristic corresponds to a credit characteristic of the user. The second credit characteristic corresponds to a credit characteristic of an owner group associated with the respective multimedia data. The third credit characteristic corresponds to a credit characteristic of users associated with the target media position. The users include visiting users and clicking users. The processing circuitry selects, based on the outcomes associated with the plurality of multimedia data, the target multimedia data from the plurality of multimedia data. The information processing apparatus includes interface circuitry that sends the target multimedia data to the terminal to be published at the target media position.

According to another aspect of the embodiments of this application, a non-transitory computer-readable medium is provided. The non-transitory computer-readable medium stores a program executable by a processor to perform obtaining a user identifier of a user using a terminal and a target media position that is used to publish target multimedia data by the terminal. A plurality of multimedia data to be published is acquired. An outcome, associated with each of the plurality of multimedia data when the respective multimedia data is published at the target media position, is determined based on a set of characteristics. The set of characteristics includes at least one of a first credit characteristic, a second credit characteristic and a third credit characteristic, a user characteristic of the user identifier, a content characteristic of the respective multimedia data, and a position characteristic of the target media position. The first credit characteristic corresponds to a credit characteristic of the user. The second credit characteristic corresponds to a credit characteristic of an owner group associated with the respective multimedia data. The third credit characteristic corresponds to a credit characteristic of users associated with the target media position. The users include visiting users and clicking users. The target multimedia data is selected from the plurality of multimedia data based on the outcomes associated with the plurality of multimedia data. The target multimedia data is sent to the terminal to be published at the target media position.

The technical solutions provided in the embodiments of the present disclosure have the following beneficial effects:

by acquiring a user identity of a terminal, and determining a target media position of the terminal, for each piece of the to-be-published multimedia data, when published target data is calculated, at least one of a user, multimedia data, and a credit feature of a target media position is introduced, and the impact of the credit feature on the published target data is considered, which improves flexibility, and improves an accuracy rate of the published target data, so as to improve a publishing accuracy rate and a conversion rate of the multimedia data, when target multimedia data is selected according to the published target data.

### BRIEF DESCRIPTION OF THE DRAWINGS

To describe the technical solutions of the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings.

FIG. 1 is a schematic diagram of a system for publishing multimedia data according to an embodiment of the present disclosure;

FIG. 2 is a flowchart of a method for publishing multimedia data according to an embodiment of the present disclosure;

FIG. 3 is a schematic diagram of an apparatus for publishing multimedia data according to an embodiment of the present disclosure; and

FIG. 4 is a schematic diagram of a server according to an embodiment of the present disclosure.

### DESCRIPTION OF EMBODIMENTS

The following describes the technical solutions in the embodiments of the present disclosure with reference to the accompanying drawings in the embodiments of the present disclosure. The described embodiments are a part rather than all of the embodiments of the present disclosure. All other embodiments obtained by a person of ordinary skill in the art based on the embodiments in the present disclosure shall fall within the protection scope of the present disclosure.

Before embodiments of the present disclosure are described in detail, concepts related to the embodiments of the present disclosure are first illustrated as follows:

1. A media position refers to a position on a media application page capable of presenting multimedia data, for example, an advertising position on any application page of a terminal.

2. Multimedia data refer to video data, audio data, and the like, and the multimedia data may be presented on a media position for a user to browse, to achieve a particular advertising effect, for example, an advertisement published by an advertiser.

3. Published target data refer to target data brought for a user group to which multimedia data belongs, when the multimedia data is published at a target media position.

For example, the published target data may be published income data, and represent income brought for a user group to which multimedia data belongs, when the multimedia data is published at a target media position. For example, when multimedia data quite matching the target media position and a user is published at a target media position, a possibility that the multimedia data attracts the user increases to a great extent. This is equivalent to acquiring a potential user for a user group to which the multimedia data belongs, that is, bringing hidden income

4. A user attribute feature (or a user characteristic) refers to an attribute feature of a user, and is determined according to attribute information of the user, for example, age, gender and an education level of the user.

A content attribute feature (or a content characteristic) refers to an attribute feature of multimedia data, and is determined according to attribute information of the multimedia data, for example, a type, a format, and a data length of the multimedia data.

A position attribute feature (or a position characteristic) refers to an attribute feature of a media position, and is determined according to attribute information of the media position, for example, a type, a publishing condition, a position of the media position.

5. A first credit feature (or a first credit characteristic) refers to a credit feature (or a credit characteristic) of a user that currently accesses a target media position, and may represent a credit level of the user.

A second credit feature (or a second credit characteristic) refers to a credit feature of a user group (or an owner group) that multimedia data belongs to, that is, a credit feature of a user group that publishes the multimedia data, may represent a credit level of the user group, and represents a credit level of the multimedia data to an extent. The user group includes a plurality of member users, and the second credit feature may be synthetically determined according to credit levels of the plurality of member users.

A third credit feature (or a third credit characteristic) refers to a credit feature of a user that a target media position is oriented to, and may be determined by an access user credit feature and a clicking user credit feature of the target media position. The access user credit feature may represent a credit level of a user that accesses the target media position, and the clicking user credit feature may represent a credit level of a user that clicks on the target media position. Because an access user (or a visiting user) and a clicking user may be considered as users matching the target media position, the third credit feature may represent a credit level of the target media position to an extent.

Note that the foregoing first credit feature, the second credit feature and the third credit feature are all determined according to a credit feature of one or more users. For a user, a credit feature of the user may be determined according to data of the user, for example, online behavior data or offline behavior data. Particularly, a credit feature may be determined according to financial data of a user, for example, credit card documentation and bank loan documentation. The data may indicate a current financial condition of the user, and reflects a credit level of the user in a period in the future to an extent.

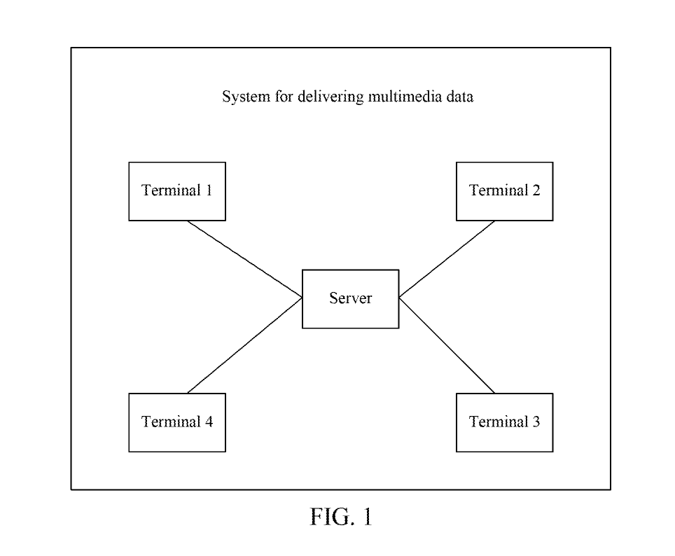

FIG. 1 is a schematic diagram of a system for publishing multimedia data according to an embodiment of the present disclosure. Referring to FIG. 1, the system for publishing multimedia data includes a server and a plurality of terminals (in FIG. 1, four terminals are used as an example). The server may provide each terminal with multimedia data publishing service.

For any terminal, the terminal includes a lot of media positions. When the server is to publish multimedia data at a target media position of the terminal, a user identity (or a user identifier) of the terminal may be acquired, a target media position of the terminal may be determined, and a plurality of pieces of to-be-published multimedia data may be acquired. Published target data is obtained by calculating according to a feature of each piece of the multimedia data, a feature of a user that the user identity is corresponding to, and a feature of the target media position. Greater target multimedia data of the published target data is selected to publish at the target media position. When the user is browsing the media application page, the target multimedia data can be browsed at the target media position.

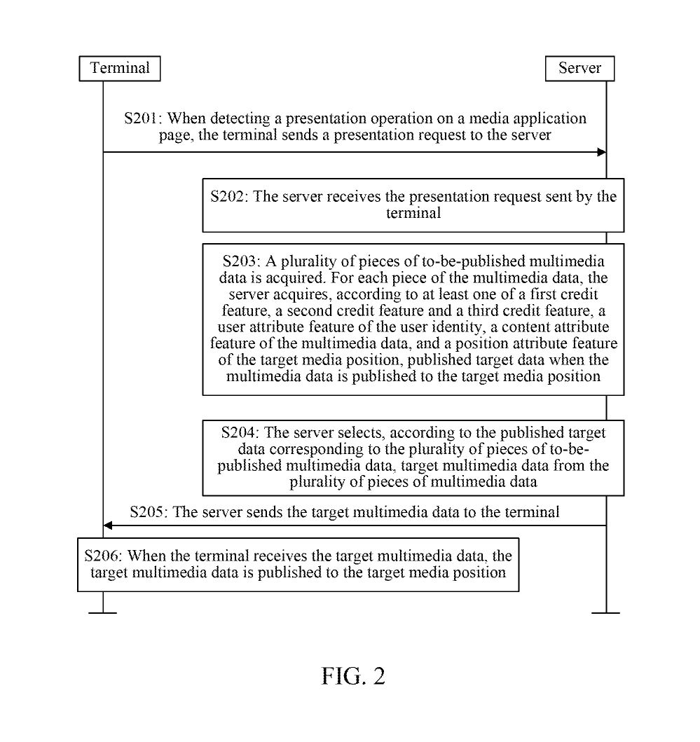

FIG. 2 is a flowchart of a method for publishing multimedia data according to an embodiment of the present disclosure. The embodiment of the present disclosure is applied to the system for publishing multimedia data shown in FIG. 1, and interaction subjects are a server and a terminal. Referring to FIG. 2, the method includes the following:

In step S201, when detecting a presentation operation on a media application page, the terminal sends a presentation request to the server.

In step S202, the server receives the presentation request sent by the terminal.

The media application may include a website, application software, and the like. The media application page may be any page in the media application, for example, a webpage and social application software, which is not limited in the embodiment of the present disclosure. The terminal may be a terminal that can access a media application, for example, a mobile phone and a personal computer. The terminal may log in to the media application based on a user identity. The user identity is used for uniquely determining a corresponding user, may be a user account, a user nickname, or the like registered on the server, or may alternatively be a device number, a phone number, or the like of the terminal, which is not limited in the embodiment of the present disclosure.

When the user expects to open the media application page, a presentation operation on the media application page is triggered. When the terminal detects the presentation operation, to determine content to be presented on media application page, the terminal sends a presentation request to the server. The presentation request carries the user identity, to request to acquire the media application page.

In actual application, the media application page includes not only content to be presented, but also a media position, and multimedia data may be published at the media position. Therefore, when the terminal sends a presentation request, the presentation request may farther carry a target media position on the media application page, so that the server can publish multimedia data at the target media position. When the server receives the presentation request, the server may acquire the user identity of the terminal and the target media position according to the presentation request.

A media application page may include one or more target media positions. The target media position may be any position located on the media application page, and the target media position may present different types of multimedia data such as picture data, audio data and video data, which is not limited in the embodiment of the present disclosure.

To facilitate the server to differentiate different target media positions, the presentation request may specifically carry attribute information of the target media positions, for example, titles of media applications where the target media positions are located, addresses of pages where the target media positions are located, types of the target media positions, context information of the target media positions in the media application pages, which is not limited in the embodiment of the present disclosure.

In step S203, a plurality of pieces of to-be-published multimedia data is acquired. For each piece of the multimedia data, the server acquires, according to at least one of a first credit feature u₁, a second credit feature a₁ and a third credit feature m, a user attribute feature u₀ of the user identity, a content attribute feature a₀ of the multimedia data, and a position attribute feature c₀ of the target media position, published target data W when the multimedia data is published to the target media position.

The server stores the plurality of pieces of to-be-published multimedia data. When the server receives the presentation request, the server acquires the plurality of pieces of to-be-published multimedia data, and selects target multimedia data from the plurality of pieces of to-be-published multimedia data, to publish to the target media position. The plurality of pieces of multimedia data may be uploaded to the server by a plurality of advertisers, or be uploaded to the server by any network user, which is not limited in the embodiment of the present disclosure.

Specifically, step S203 may include any one of the following manners:

A first manner: acquiring according to the first credit feature u₁, the third credit feature m, the user attribute feature u₀, the content attribute feature a₀ and the position attribute feature c₀, including step S203, sub steps 1 to 3:

In step S203, sub step 1, the server forms a user feature (or a combined user characteristic) u′ by using the first credit feature u₁ and the user attribute feature u₀.

The server may acquire a credit feature and an attribute feature corresponding to each user identity in advance. When the server receives the presentation request, the first credit feature u₁ and the user attribute feature u₀ may be acquired. The user feature u′ is formed by using u₁ and u₀, that is, u′=(u₁, u₀).

The user attribute feature is used for representing a basic attribute of a user, and may be determined according to attribute information of the user. The attribute information may include age, gender, an education level, hobby, profession, and the like, which is not limited in the embodiment of the present disclosure.

The credit feature is used for representing a level of a user credit level, and may be determined according to data of the user. The data may include financial data, online behavior data, offline behavior data, and the like.

First, financial data includes, but is not limited to: credit information, public record, and the like of a user. The credit information includes credit card documentation, bank loan documentation, personal asset record and other credit records. The public record includes a record such as an individual housing provident fluid, or individual old-age insurance, which is not limited in the embodiment of the present disclosure.

The financial data is acquired according to a financial condition of the user in a period in the past or an operation performed on related financial information, may be obtained by the server by using user information filled in various applications in a mobile phone, a tablet computer or a personal computer by the user, or may be acquired by reporting by various applications related to finance according to an operation of the user. The applications related to finance may include a financing management platform, shopping software, and the like. Alternatively, the financial data may be sent to the server after acquired by a third party server. The third party server may be a bank server, an insurance company server, and the like, which is not limited in the embodiment of the present disclosure.

Second, online behavior data includes, but is not limited to:

1. basic population attribute information of a user such as name, age, gender, area, an education level, and profession;

2. virtual value-added service data, such as virtual account role play, game prop purchase, film member service, cloud storage space value-added service, and music data package;

3. social interaction behavior data, such as chatting, email, voice communication, microblog space publishing, Douban comments, Zhihu question answering, and official account passage reading;

4. economic behavior data, such as payment, financing management, shopping, stock, fund, P2P, and finance;

5. entertainment and leisure behavior data, such as video on demand, playing music, singing, and reading news;

6. educational behavior data, such as online reading, public class learning, professional examination exercises, skill training, and translation software usage; and

7. other Internet mobile application behavior data, such as App downloading, and searching.

Third, offline behavior data includes, but is not limited to:

1. O2O (online to offline) life service information, such as housekeeping service, city service, and aesthetic health care;

2. wearable device data, such as medical health, and exercise;

3. LBS (location based service) geographic position data, such as guiding, signing in, and a special vehicle; and

4. tourism trip data, such as ticket business ordering, and hotel reservation.

The foregoing offline behavior data and online behavior data may be obtained by using user information filled in various applications in a mobile phone, a tablet computer or a personal computer by the user, or may be acquired by reporting by the various applications according to an operation of the user. The applications may include an instant messaging application program, a game client, an APP downloading platform, a financing management platform, shopping software, which is not limited in the embodiment of the present disclosure.

In step S203, sub step 2, acquire the third credit feature m according to an access user credit feature A (or a visitor credit characteristic associated with the visiting users) and a clicking user credit feature B (or a clicker credit characteristic associated with the clicking users) of the target media position.

The third credit feature m represents a level of a credit level of a user that the target media position is oriented to. The user that the target media position is oriented to may include an access user and a clicking user. The access user refers to a user that accesses the target media position, that is, a user views the target media position after opening the media application page. The clicking user refers to a user that clicks on the target media position, that is, a user clicks on the target media position after publishing each piece of multimedia data at the target media position.

Optionally, step S203, sub step 2, may include the following steps 1 to 3:

In step 1, the server acquires a first credit distribution feature (or a first credit distribution characteristic) M according to credit features of a plurality of access users of the target media position in a plurality of preset time periods.

Aᵢⱼ is used for representing a credit feature of an ith access user of the target media position in a jth time period, a formula Mⱼ=F(A₁ⱼ, A₂ⱼ, . . . , Aₙⱼ) may be applied to acquire a credit distribution feature Mⱼ in the jth time period, and combine credit distribution features of a plurality of time periods into the first credit distribution feature M, that is, M=(M₁, M₂, . . . , Mⱼ, . . . Mₚ). n represents the number of access users, i∈(1,n), p represents the number of time periods, j∈(1,p), and F(•) represents a distribution function, and may be a frequency statistical function, a frequency conversion function, and the like, which is not limited in the embodiment of the present disclosure.

In step 2, the server acquires a second credit distribution feature (or a second credit distribution characteristic) N according to credit features of a plurality of clicking users of the target media position in the plurality of preset time periods.

When the second credit distribution feature N is acquired, Bᵢⱼ represents a credit feature of an ith clicking user of the target media position in a jth time period, a formula Nⱼ=F(B₁ⱼ, B₂ⱼ, . . . , Bₛⱼ) may be applied to acquire a credit distribution feature Nⱼ in the jth time period, and combine credit distribution features of a plurality of time periods into the second credit distribution feature N, that is, N=(N₁, N₂ . . . Nⱼ, . . . , N_{q}). s represents the number of clicking users, i∈(1,s), q represents the number of time periods, j∈(1,q).

In step 3, the server acquires a difference feature (or a difference characteristic) D between the first credit distribution feature M and the second credit distribution feature N, and forms the third credit feature m by using the first credit distribution feature M and the difference feature D.

After the first credit distribution feature M and the second credit distribution feature N are acquired, a formula D=P(M, N) is applied to calculate the difference feature D, and the third credit feature m=(M, D). P(•) may be functions such as a KL distance (Kullback-Leibler divergence, relative entropy) function, and a ψ distance function. A distance between M and N may be as the difference feature by using the distance functions. P(•) is not limited in the embodiment of the present disclosure.

The foregoing steps 1 to 3 use first calculating M and N and then calculating D as an example. In actual application, for each time period, the first credit distribution feature Mⱼ of a plurality of access users in the time period and the second credit distribution feature Nⱼ of a plurality of clicking users its the time period may also be calculated first. Then Dⱼ=P(Mⱼ,Nⱼ) is calculated to obtain a difference feature of each time period, and difference features of a plurality of time periods are combined into D. A calculation sequence of the server is not limited in the embodiment of the present disclosure.

In step S203, sub step 3, acquire the published target data W according to the user feature u′, the content attribute feature a₀, the position attribute feature c₀, and the third credit feature m.

The content attribute feature a₀ is determined according to attribute information of the multimedia data. The attribute information of the multimedia data may include information such as the multimedia data, a type of the multimedia data, publishing time of the multimedia data, or a publisher, which is not limited in the embodiment of the present disclosure. The position attribute feature c₀ is determined according to attribute information of the target media position. The attribute information of the target media position may include a name, a type and an address of the media application page, context information of the target media position on the media application page, or the like, which is not limited in the embodiment of the present disclosure.

Optionally, the server applies a formula W=μ(a₀,u′,c₀)*v(a₀,u′,m) to acquire the published target data, where μ(a₀, u′,c₀) represents a click-through rate when the multimedia data is published to the target media position, that is, a probability that a user browsing the multimedia data clicks on the target media position, and v(a₀,u′, m) represents a click value when the multimedia data is published to the target media position, that is, a value produced when a user clicks on the target media position each time. A product of the click-through rate and the click value is the published target data.

The click-through rate μ(a₀, u′, c₀) may be calculated by using a function used for predicting a click-through rate, or may be calculated by using a click-through rate prediction model trained in advance. The click vale v(a₀, u′, m) may be calculated by using a function used for predicting a click value, or may be calculated by using a click value prediction model trained in advance. Calculation manners of the click-through rate and the click value are not limited in the embodiment of the present disclosure.

Note that the published target data W is used for measuring target data produced when to-be-published maimed is data is published to a target media position. Greater published target data W indicate greater target data produced when the to-be-published multimedia data is published to the target media position, and less published target data W indicate less target data produced when the to-be-published multimedia data is published to the target media position.

In a possible implementation, the published target data may be published income data, configured to measure income produced when multimedia data is published to a target media position. Greater published income data indicate greater income produced when the multimedia data is published to the target media position, and less published income data indicate less income produced when the multimedia data is published to the target media position.

A second manner: acquiring according to the second credit feature a₁, the user attribute feature the content attribute feature a₀ and the position attribute feature c₀, including steps S2034 and S2035:

In step S203, sub step 4, the server acquires the second credit feature a₁ according to credit features and weight coefficients of a plurality of member users included in the user group to which the multimedia data belongs, and forms a content feature (or a combined content characteristic) a′ of the multimedia data by using the second credit feature a₁ and the content attribute feature a₀ of the multimedia data, that is, a′ (a₁, a₀).

The user group to which the multimedia data belongs represents a user group that publishes the multimedia data, and may be an institution, a group, an enterprise, or the like, which is not limited in the embodiment of the present disclosure. The user group includes a plurality of member users, credit levels of the plurality of members may represent a credit level of the user group to an extent. Higher credit levels of the plurality of members indicate a higher credit level of the user group, and lower credit levels of the plurality of members indicate a lower credit level of the user group. Therefore, the second credit feature may be determined according to credit features of the plurality of member users.

Optionally, the server acquires a product value of a credit feature Cⱼ and a weight coefficient αⱼ of each of the member users j, to obtain a weighted credit feature (or a weighted credit characteristic) αⱼCⱼ, acquire a sum value of the weighted credit features of the plurality of member users, and obtain the second credit feature a₁. That is, a formula a₁=Z(α₁,C₁,α₂C₂, . . . , αₖCₖ) is applied to calculate, Z(•) represents a sum function, and k represents the number of the members of the user group.

In step S203, sub step 5, acquire the published target data W according to the user attribute feature u₀, the content feature a′ and the position attribute feature c₀.

Optionally, the server applies a formula W=μ(a′, u₀, c₀)*v(a′, u₀) to acquire the published target data. μ(a′,u₀, c₀) represents a click-through rate when the multimedia data is) published to the target media position, and v(a′,u₀) represents a click value when the multimedia data is published to the target media position.

Calculation methods of the click-through rate, the click value and the published target data in step S203, sub step 5, are similar to those in step S203, sub step 3, and details are not described herein again.

A third manner: acquiring according to the first credit feature u₁, the second credit feature a₁, the third credit feature m the user attribute feature u₀, the content attribute feature a₀, and the position attribute feature c₀, including steps S203, sub steps 6 to 9:

In step S203, sub step 6, the server forms the user feature u′ by using the first credit feature and the user attribute feature.

In step S203, sub step 7, acquire the second credit feature a₁ according to the credit features and the weight coefficients of the plurality of member users included in the user group to which the multimedia data belongs, and form the content feature a′ of the multimedia data by using the second credit feature and the content attribute feature of the multimedia data.

In step S203, sub step 8, acquire the third credit feature m according to an access user credit feature and a clicking user credit feature of the target media position.

Step S203, sub step 6 is similar to the foregoing step S203 sub step 1, step S203, sub step 7 is similar to the foregoing step S203 sub step 4, and step S203 sub step 9 is similar to those in step S203 sub step 2, and details are not described herein again.

In step S203, sub step 9, acquire the published target data W according to the user feature u′, the content feature a′, the third credit feature m, and the position attribute feature c₀ of the target media position.

Optionally, a formula W=(a′,u′,c₀, m)*v(a′,u′, m) is acquired to acquire the published target data. μ(a′,u′,c₀, m) represents a click-through rate when the multimedia data is published to the target media position, and v(a′,u′, m) represents a click value when the multimedia data is published to the target media position.

Calculation methods of the click-through rate, the click value and the published target data in step S203, sub step 9 are similar to those in step S203, sub step 3, details are not described herein again.

In step S204, the server selects, according to the published target data corresponding to the plurality of pieces of to-be-published multimedia data, target multimedia data from the plurality of pieces of multimedia data.

Greater published target data of the multimedia data indicates greater target data produced when the multimedia data is published to the target media position. Therefore, the server sorts a plurality of pieces of multimedia data in descending order of published target data after calculating published target data of the plurality of pieces of multimedia data, and selects a preset number of pieces of multimedia data ranking top, as target multimedia data to publish to the target media position. The preset number may be determined by the terminal, or be determined by the server in advance, or be determined by the server according to a total number of pieces of to-be-published multimedia data and a preset ratio, which is not limited in the embodiment of the present disclosure.

For example, a determined number of the plurality of pieces of multimedia data is five, the five pieces of multimedia data and published target data corresponding thereto are shown in Table 1. If the preset number is three, target multimedia data A2, A4, and A1 ranking top 3 is selected to publish to the target media position.

TABLE 1

| Multimedia Data A | Published Target Data W |
|---|---|
| A1 | 10 |
| A2 | 40 |
| A3 | 8 |
| A4 | 11 |
| A5 | 9 |

In addition, if some multimedia data sets a publishing condition, the server first selects multimedia data whose publishing condition may be satisfied by the target media position and the user identity, from a plurality of pieces of multimedia data, and then selects target multimedia data from the multimedia data in descending order of published target data.

In step S205, the server sends the target multimedia data to the terminal.

In step S206, when the terminal receives the target multimedia data, the target multimedia data is published to the target media position.

The server not only sends the target multimedia data to the terminal, but also sends the media application page to the terminal. The terminal presents the media application page, and publishes the target multimedia data to the target media position, thereby presenting the target multimedia data at the target media position on the media application page.

For example, when the target multimedia data is picture data, the terminal presents the picture data at the target media position. Alternatively, when the target multimedia data is video data, the terminal plays the video data at the target media position.

Further, when the server sends a plurality of pieces of target multimedia data to the terminal, the terminal may publish the plurality of pieces of target multimedia data to the target media position, that is, scrolling present the plurality of pieces of target multimedia data at the target media position.

In a possible application scenario, publishing multimedia data may be delivering an advertisement. Correspondingly, publishing the target multimedia data to the target media position is delivering a target advertisement at the target media position.

A first point to be noted is that the embodiment of the present disclosure is described by using that when a server receives a presentation request of a terminal, the server determines to-be-published target multimedia data for the terminal, as an example. However, in actual application, the server may further use the method provided in the embodiment of the present disclosure to acquire a user identity of a terminal and determine a target media position of the terminal, determine to-be-published target multimedia data for the target media position of the terminal, send the target multimedia data to the terminal at any time. The received target multimedia data is published to the target media position by the terminal, to present to a user.

A second point to be noted is that the embodiment of the present disclosure is described by using a terminal as an example. In fact, a plurality of terminals needs to open media application pages. Multimedia data needs to be published at target media positions of the media application pages. The server may determine to-be-published target multimedia data for the plurality of terminals, and send the target multimedia data to the corresponding terminals. The acquired target multimedia data is presented at a target media positions by each terminal.

Further, in the embodiment of the present disclosure, the server calculates published target data of a plurality of pieces of multimedia data for the terminal, to select multimedia data of greater published target data to publish. In actual application, when the server publishes for a plurality of terminals, the server may publish with a purpose of a greatest total number of published target data. That is, for a plurality of pieces of multimedia data and a plurality of target media positions, the server may combine the plurality of pieces of multimedia data with the plurality of target media positions in different manners, thereby working out various publishing strategies. Each publishing strategy includes a plurality of publishing combinations. Each publishing combination includes multimedia data and a target media position corresponding to each other. The server uses the manner provided in the embodiment of the present disclosure to calculate published target data of each publishing combination, thereby calculating a sum of published target data of the plurality of publishing combinations in each publishing strategy, that is, a total number of published target data of each publishing strategy. In this case, a publishing strategy of a greatest total number of published target data may be selected, to publish according to a plurality of publishing combinations in the selected publishing strategy.

By using the manner, a plurality of target media positions may be roundly considered, instead of a single target media position. This can optimize a global publishing strategy, and ensure maximization of published target data.

A third point to be noted is that the embodiment of the present disclosure is described by using that a same server provides a terminal with a media application page and publishes multimedia data at a target media position, as an example. However, in actual application, a media application page may be provided and multimedia data may be published by different servers respectively.

For example, a media application server provides a terminal with to-be-presented media application page, and a publishing management server is configured to publish multimedia data at a target media position of the media application page. When the terminal detects a presentation operation on a media application page, the server sends a presentation request to the media application server. The presentation request is sent to the publishing management server by the media application server. Then the media application server returns the media application page to the terminal. After the publishing management server sends the multimedia data to the terminal, the terminal may publish the multimedia data at the target media position.

In views of different needs of users of different credit levels to multimedia data, in the embodiment of the present disclosure, the impact of a credit level on publishing multimedia data is considered. Published target data is calculated according to credit features of a user, multimedia data and a target media position. Suitable target multimedia data is selected for the target media position to publish according to calculated published target data. More accurate calculation on the published target data makes publishing of the target multimedia data more accurate. This satisfies the different needs of the users of the different credit levels to the multimedia data.

In the method provided in the embodiment of the present disclosure, by receiving a presentation request sent by a terminal, for each piece of the to-be-published multimedia data, when published target data is calculated, at least one of a user, multimedia data, and a credit feature of a target media position is introduced, and the impact of the credit feature on the published target data is considered, which improves flexibility, and improves an accuracy rate of the published target data, so as to improve a publishing accuracy rate and a conversion rate of the multimedia data, when target multimedia data is selected according to the published target data.

Further, in the embodiment of the present disclosure, by combining a credit feature of an access user and a credit feature of a clicking user, financial consumption tendencies of users that a target media position is oriented to may be indirectly introduced, the impact of financial conditions of the users on target multimedia data published to the target media position may be reflected. In addition, when a first credit distribution feature and a difference feature between the first credit distribution feature and a second credit distribution feature are added, a value of target multimedia data may be evaluated for different media applications. The foregoing descriptions are beneficial to adjusting a publishing strategy of target multimedia data, reducing presentation of obstructed multimedia data, avoiding interference to a user, thereby improving a conversion rate of the target multimedia data.

In addition, by combing a credit feature of a user group to which target multimedia data belongs, a determining ability on multimedia data quality of the user group may be improved. This is beneficial to evaluating a value of target multimedia data, is beneficial to allocate different target multimedia data traffic to different media applications, reduces presentation of target multimedia data of low quality, thereby improving a click-through rate of target multimedia data, and improving a reputation and a conversion rate of the target multimedia data.

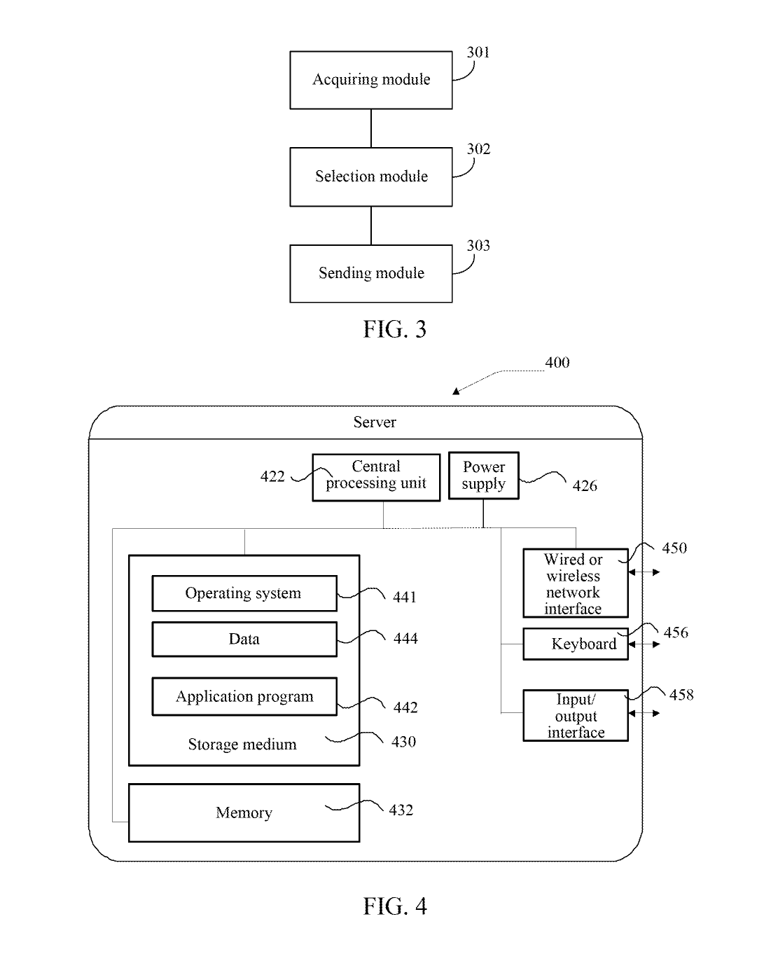

FIG. 3 is a schematic diagram of an apparatus for publishing multimedia data according to an embodiment of the present disclosure. Referring to FIG. 3, the apparatus includes an acquiring module 301, a selection module 302, and a sending module 303.

The acquiring module 301 is configured to perform the foregoing steps S202 and S203.

The selection module 302 is configured to perform the foregoing step S204.

The sending module 303 is configured to perform the foregoing step S205.

In the apparatus provided in the embodiment of the present disclosure, by receiving a presentation request sent by a terminal, for each piece of the to-be-published multimedia data, when published target data is calculated, at least one of a user, multimedia data, and a credit feature of a target media position is introduced, and the impact of the credit feature on the published target data is considered, which improves flexibility, and improves an accuracy rate of the published target data, so as to improve a publishing accuracy rate and a conversion rate of the multimedia data, when target multimedia data is selected according to the published target data.

Note that when the apparatus for publishing multimedia data provided in the foregoing embodiment publishes multimedia data, it is illustrated with an example of division of the foregoing function modules. In practical application, the foregoing functions may be distributed to different function modules according to requirements, that is, the internal structure of the server is divided into different function modules, so as to complete all or part of the functions described above. In addition, the embodiment of the method for publishing multimedia data provided in the foregoing embodiment belongs to the same concept as the embodiment of the apparatus for publishing multimedia data. For a specific implementation process of the apparatus, refer to the method embodiment, and details are not described herein again.

FIG. 4 is a schematic diagram of a server according to an embodiment of the present disclosure. The server 400 may vary greatly due to different configurations or performance, and may include one or more central processing units (CPUs) 422 (for example, one or more processors), a memory 432, and one or more storage mediums 430 (for example, one or more mass storage devices) that store an application program 442 or data 444. The memory 432 and the storage medium 430 may be transient or persistent storages. A program stored in the storage medium 430 may include one or more modules (not shown), and each module may include a series of instruction operations in the server. Still further, the CPU 422 may be configured to communicate with the storage medium 430, and perform, on the server 400, a series of instructions and operations in the storage medium 430.

The server 400 may further include one or more power supplies 426, one or more wired or wireless network interfaces 450, one or more input/output interfaces 458, one or more keyboards 456, and/or one or more operating systems 441, for example, Windows Server™, Mac OS X™, Unix™, Linux™, or FreeBSD™.

The server 400 may be configured to perform steps performed by a server in the method for publishing multimedia data provided in the foregoing embodiments.

It is noted that the various modules, sub-modules, units, and components in the present disclosure can be implemented using any suitable technology. For example, a module may be implemented using circuitry, such as an integrated circuit (IC). As another example, a module may be implemented as a processing circuit executing software instructions.

An embodiment of the present disclosure further provides a computer readable storage medium. The computer readable storage medium stores at least one instruction, at least one program, a code set or an instruction set. The instruction, the program, the code set or the instruction set is loaded and executed by a processor to implement the operations performed in the method for publishing multimedia data according to the foregoing embodiments. For example, the computer readable storage medium may be a non-transitory computer readable storage medium such as a ROM, a random access memory (RAM), a CD-ROM, a magnetic tape, a floppy disk, or an optical data storage device.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for publishing multimedia data, comprising:
obtaining, by processing circuitry of an information processing apparatus, a user identifier of a user using a terminal and a target media position that is used to publish target multimedia data by the terminal;
acquiring a plurality of multimedia data to be published;
determining, based on a set of characteristics, an outcome associated with each of the plurality of multimedia data when the respective multimedia data is published at the target media position, the set of characteristics including at least one of a first credit characteristic, a second credit characteristic and a third credit characteristic, a user characteristic of the user identifier, a content characteristic of the respective multimedia data, and a position characteristic of the target media position, the first credit characteristic corresponding to a credit characteristic of the user, the second credit characteristic corresponding to a credit characteristic of an owner group associated with the respective multimedia data, the third credit characteristic corresponding to a credit characteristic of users associated with the target media position, the users including visiting users and clicking users;
selecting, based on the outcomes associated with the plurality of multimedia data, the target multimedia data from the plurality of multimedia data; and
sending, by interface circuitry of the information processing apparatus, the target multimedia data to the terminal to be published at the target media position.

2. The method according to claim 1, wherein the determining the outcome associated with the respective multimedia data when the respective multimedia data is published at the target media position comprises:
forming a combined user characteristic using the first credit characteristic and the user characteristic;
determining the third credit characteristic based on a visitor credit characteristic associated with the visiting users and a clicker credit characteristic associated with the clicking users; and
determining the outcome based on the combined user characteristic, the content characteristic, the position characteristic and the third credit characteristic.

3. The method according to claim 2, wherein the determining the outcome based on the combined user characteristic u′ the content characteristic a₀, the position characteristic c₀, and the third credit characteristic m comprises:
determining the outcome W using the following equation:
W=μ(a′,u′,c₀)*v(a₀,u′,m), wherein
μ(a₀, μ′, c₀), dependent on the content characteristic a₀, the combined user characteristic u′, and the position characteristic c₀, represents a click-through rate when the respective multimedia data is published at the target media position and v(a₀, μ′, m), dependent on the content characteristic a₀, the combined user characteristic u′, and the third credit characteristic m, represents a click value when the respective multimedia data is published at the target media position.

4. The method according to claim 1, wherein the determining the outcome associated with the respective multimedia data when the respective multimedia data is published at the target media position comprises:
determining the second credit characteristic based on credit characteristics and weight coefficients of respective members in the owner group associated with the respective multimedia data;
forming a combined content characteristic of the respective multimedia data using the second credit characteristic and the content characteristic; and
determining the outcome based on the user characteristic, the combined content characteristic, and the position characteristic.

5. The method according to claim 4, wherein the determining the outcome based on the user characteristic u₀, the combined content characteristic a′ and the position characteristic c₀ comprises:
determining the outcome W using the following equation:
W=μ(a′,u₀,c₀)*v(a′,u₀), wherein
μ(a′, u₀, c₀), dependent on the combined content characteristic a′, the user characteristic u₀, and the position characteristic c₀, represents a click-through rate when the respective multimedia data is published at the target media position and v(a′,u₀), dependent on the combined content characteristic a′ and the user characteristic u₀, represents a click value when the respective multimedia data is published at the target media position.

6. The method according to claim 1, wherein the determining the outcome associated with the respective multimedia data when the respective multimedia data is published at the target media position comprises:
forming a combined user characteristic using the first credit characteristic and the user characteristic;
determining the second credit characteristic based on credit characteristics and weight coefficients of respective members in the owner group associated with the respective multimedia data;
forming a combined content characteristic of the respective multimedia data using the second credit characteristic and the content characteristic;
determining the third credit characteristic based on a visitor credit characteristic associated with the visiting users and a clicker credit characteristic associated with the clicking users; and
determining the outcome based on the combined user characteristic, the combined content characteristic, the third credit characteristic, and the position characteristic.

7. The method according to claim 6, wherein the determining the outcome based on the combined user characteristic u′, the combined content characteristic a′, the third credit characteristic m, and the position characteristic c₀ comprises:
determining the outcome W using the following equation:
W=μ(a′,u′,c₀,m)*v(a′,u′,m), wherein
μ(a′,u′,c₀,m), dependent on the combined content characteristic a′, the combined user characteristic u′, the position characteristic c₀, and the third credit characteristic m, represents a click-through rate when the respective multimedia data is published at the target media position and v(a′,u′,m), dependent on the combined content characteristic a′, the combined user characteristic u′, and the third credit characteristic m, represents a click value when the respective multimedia data is published at the target media position.

8. The method according to claim 2, wherein the determining the third credit characteristic based on the visitor credit characteristic associated with the visiting users and the clicker credit characteristic associated with the clicking users comprises:
determining a first credit distribution characteristic based on respective credit characteristics of the visiting users in first preset time periods;
determining a second credit distribution characteristic based on respective credit characteristics of the clicking users in second preset time periods;
determining a difference characteristic between the first credit distribution characteristic and the second credit distribution characteristic; and
forming the third credit characteristic using the first credit distribution characteristic and the difference characteristic.

9. The method according to claim 4, wherein the determining the second credit characteristic based on the credit characteristics and the weight coefficients of the respective members in the owner group associated with the respective multimedia data comprises:
for each of the members in the owner group, determining a weighted credit characteristic that is a product of one of the credit characteristics associated with the respective member and one of the weight coefficients associated with the respective member; and
determining the second credit characteristic to be a sum of the weighted credit characteristics associated with the members in the owner group.

10. The method according to claim 1, Wherein the obtaining the user identifier and the target media position comprises:
receiving, by the interface circuitry of the information processing apparatus, a presentation request from the terminal, the presentation request including the user identifier and the target media position.

11. An information processing apparatus for publishing multimedia data, comprising:
processing circuitry configured to:
obtain a user identifier of a user using a terminal and a target media position that is used to publish target multimedia data by the terminal;
acquire a plurality of multimedia data to be published;
determine, based on a set of characteristics, an outcome associated with each of the plurality of multimedia data when the respective multimedia data is published at the target media position, the set of characteristics including at least one of a first credit characteristic, a second credit characteristic and a third credit characteristic, a user characteristic of the user identifier, a content characteristic of the respective multimedia data, and a position characteristic of the target media position, the first credit characteristic corresponding to a credit characteristic of the user, the second credit characteristic corresponding to a credit characteristic of an owner group associated with the respective multimedia data, the third credit characteristic corresponding to a credit characteristic of users associated with the target media position, the users including visiting users and clicking users; and
select, based on the outcomes associated with the plurality of multimedia data, the target multimedia data from the plurality of multimedia data; and
interface circuitry configured to send the target multimedia data to the terminal to be published at the target media position.

12. The information processing apparatus according to claim 11, wherein the processing circuitry is further configured to:
form a combined user characteristic using the first credit characteristic and the user characteristic;
determine the third credit characteristic based on a visitor credit characteristic associated with the visiting users and a clicker credit characteristic associated with the clicking users; and
determine the outcome based on the combined user characteristic, the content characteristic, the position characteristic and the third credit characteristic.

13. The information processing apparatus according to claim 12, wherein
μ(a₀,μ′,c₀), dependent on the content characteristic a₀, the combined user characteristic u′, and the position characteristic c₀, represents a click-through rate when the respective multimedia data is published at the target media position;
v(a₀,μ′,m), dependent on the content characteristic a₀, the combined user characteristic u′, and the third credit characteristic m, represents a click value when the respective multimedia data is published at the target media position; and
the processing circuitry is further configured to determine the outcome W using the following equation: W=μ(a₀,u′,c₀)*v(a₀,u′, m).

14. The information processing apparatus according to claim 11, wherein the processing circuitry is further configured to:
determine the second credit characteristic based on credit characteristics and weight coefficients of respective members in the owner group associated with the respective multimedia data;
form a combined content characteristic of the respective multimedia data using the second credit characteristic and the content characteristic; and
determine the outcome based on the user characteristic, the combined content characteristic, and the position characteristic.

15. The information processing apparatus according to claim 14, wherein
μ(a′,u₀,c₀), dependent on the combined content characteristic a′, the user characteristic u₀, and the position characteristic c₀, represents a click-through rate when the respective multimedia data is published at the target media position;
v(a′,u₀), dependent on the combined content characteristic a′ and the user characteristic u₀, represents a click value when the respective multimedia data is published at the target media position; and
the processing circuitry is further configured to determine the outcome W using the following equation: W=μ(a′,u₀,c₀)*v(a′,u₀).

16. The information processing apparatus according to claim 11, wherein the processing circuitry is further configured to:
form a combined user characteristic using the first credit characteristic and the user characteristic;
determine the second credit characteristic based on credit characteristics and weight coefficients of respective members in the owner group associated with the respective multimedia data;
form a combined content characteristic of the respective multimedia data using the second credit characteristic and the content characteristic;
determine the third credit characteristic based on a visitor credit characteristic associated with the visiting users and a clicker credit characteristic associated with the clicking users; and
determine the outcome based on the combined user characteristic, the combined content characteristic, the third credit characteristic, and the position characteristic.

17. The information processing apparatus according to claim 16, wherein
μ(a′,u′,c₀,m), dependent on the combined content characteristic a′, the combined user characteristic u′, the position characteristic c₀, and the third credit characteristic m, represents a click-through rate when the respective multimedia data is published at the target media position;
v(a′,u′,m), dependent on the combined content characteristic a′, the combined user characteristic u′, and the third credit characteristic m, represents a click value when the respective multimedia data is published at the target media position; and
the processing circuitry is further configured to determine the outcome W using the following equation: W=μ(a′,u′,c₀, m)*v(a′,u′, m).

18. The information processing apparatus according to claim 12, wherein the processing circuitry is further configured to:
determine a first credit distribution characteristic based on respective credit characteristics of the visiting users in first preset time periods;
determine a second credit distribution characteristic based on respective credit characteristics of the clicking users in second preset time periods;
determine a difference characteristic between the first credit distribution characteristic and the second credit distribution characteristic; and
form the third credit characteristic using the first credit distribution characteristic and the difference characteristic.

19. The information processing apparatus according to claim 11, wherein the interface circuitry is further configured to:
receive a presentation request from the terminal, the presentation request including the user identifier and the target media position.

20. A non-transitory computer-readable storage medium storing a program executable by a processor to perform:
obtaining a user identifier of a user using a terminal and a target media position that is used to publish target multimedia data by the terminal;
acquiring a plurality of multimedia data to be published;
determining, based on a set of characteristics, an outcome associated with each of the plurality of multimedia data when the respective multimedia data is published at the target media position, the set of characteristics including at least one of a first credit characteristic, a second credit characteristic and a third credit characteristic, a user characteristic of the user identifier, a content characteristic of the respective multimedia data, and a position characteristic of the target media position, the first credit characteristic corresponding to a credit characteristic of the user, the second credit characteristic corresponding to a credit characteristic of an owner group associated with the respective multimedia data, the third credit characteristic corresponding to a credit characteristic of users associated with the target media position, the users including visiting users and clicking users;
selecting, based on the outcomes associated with the plurality of multimedia data, the target multimedia data from the plurality of multimedia data; and
sending the target multimedia data to the terminal to be published at the target media position.
